(19) United States
(12) Patent Application Publication
(10) Pub. No.: US 2026/0135142 A1
(43) Pub. Date: May 14, 2026

(54) SULFIDE SOLID ELECTROLYTES, PREPARATION METHODS THEREOF, AND ALL-SOLID-STATE RECHARGEABLE BATTERIES

(71) Applicant: SAMSUNG SDI CO., LTD., Yongin-si (KR)

(72) Inventors: Jeongeun OH, Yongin-si (KR); Hyesu KIM, Yongin-si (KR); Jayhyok SONG, Yongin-si (KR); Hansol LIM, Yongin-si (KR); Jungmin HAN, Yongin-si (KR); Kyulin LEE, Yongin-si (KR); Sihyeon SUNG, Yongin-si (KR); Jinkyu KIM, Yongin-si (KR)

(21) Appl. No.: 19/361,409

(22) Filed: Oct. 17, 2025

(30) Foreign Application Priority Data
Oct. 18, 2024 (KR) 10-2024-0143295

(51) Int. Cl. H01M 10/0562; H01M 10/052

(52) U.S. Cl. CPC H01M 10/0562; H01M 10/052; H01M 2300/0068

(57) ABSTRACT

A sulfide solid electrolyte, including sulfide solid electrolyte particles, and a coating layer on a surface of the sulfide solid electrolyte particles, wherein the coating layer includes CO₃²⁻ and PO₄³⁻, and a ratio of a maximum peak intensity of the CO₃²⁻ to a peak intensity of the PO₄³⁻ in infrared spectroscopy is about 0.5 to about 1.

### CROSS-REFERENCE TO RELATED APPLICATION

This application claims priority to and the benefit of Korean Patent Application No. 10-2024-0143295 filed with the Korean Intellectual Property Office on Oct. 18, 2024, the entire contents of which are incorporated herein by reference.

### BACKGROUND

### 1. Field

The present disclosure relates to sulfide solid electrolytes, preparation methods thereof, and all-solid-state rechargeable batteries including the same.

### 2. Description of the Related Art

Recently, development of batteries with high energy density and safety is being actively pursued due to industrial demands. For example, lithium-ion batteries are being put to practical use not only in the information-related devices and communication devices fields, but also in the automobile field. In the automotive industry, safety is especially important because it is related to life.

The aforementioned information disclosed in the background technology of this disclosure is only intended to improve understanding of the background of the present disclosure and therefore may include information that does not constitute prior art.

### SUMMARY

Embodiments include a sulfide solid electrolyte, including sulfide solid electrolyte particles, and a coating layer on a surface of the sulfide solid electrolyte particles, wherein the coating layer includes CO₃²⁻ and PO₄³⁻, and a ratio of a maximum peak intensity of the CO₃²⁻ to a peak intensity of the PO₄³⁻ in Fourier transform infrared spectroscopy is about 0.5 to about 1.

The coating layer may further include SO₄²⁻.

A ratio of the PO₄³⁻ peak intensity to the SO₄²⁻ peak intensity of the coating layer may be greater than or equal to about 3 and less than or equal to about 4.25.

A ratio of the CO₃²⁻ maximum peak intensity to the SO₄²⁻ peak intensity may be about 2.5 to about 5.

The coating layer may further include OH⁻.

The coating layer may be coated on at least a portion of a surface of the sulfide solid electrolyte particles.

The coating layer may be a continuous film on the surface of a sulfide solid electrolyte particles.

The coating layer may be an island on the surface of a sulfide solid electrolyte particles.

The sulfide solid electrolyte particles may include argyrodite-type sulfide.

The argyrodite-type sulfide may include at least one of Li₃PS₄, Li₇P₃S₁₁, Li₇PS₆, Li₆PS₅Cl, Li₆PS₅Br, Li_{5.8} PS_{4.8}Cl_{1.2}, and Li_{6.2}PS_{5.2}Br_{0.8}.

An average particle diameter of the sulfide solid electrolyte particles may be about 0.1 μm to about 5.0 μm.

An average particle diameter of the sulfide solid electrolyte particles may be about 0.1 μm to about 2.0 μm.

An ionic conductivity of the sulfide solid electrolyte particles may be about 1 mS/cm to about 8 mS/cm.

Embodiments include a method for preparing a sulfide solid electrolyte, the method including exposing sulfide solid electrolyte particles to an atmosphere having a relative humidity of about 0.02% to about 0.3% to form OH⁻ on a surface of the sulfide solid electrolyte particles, and exposing the particles with OH⁻ formed on the surface to a CO₂ atmosphere to form CO₃²⁻ on the surface.

Exposing the particles to the CO₂ atmosphere may be performed for about 9 hours to about 72 hours.

Exposing the sulfide solid electrolyte particles to the CO₂ atmosphere may include exposing the sulfide solid electrolyte particles to a dry room including CO₂.

The dry room may include about 0.02 vol % to about 0.1 vol % of the CO₂.

Exposing the sulfide solid electrolyte particles to the atmosphere having the relative humidity of about 0.02% to about 0.3% may be performed at a temperature of about 15° C. to about 30° C., and exposing the sulfide solid electrolyte particles to the CO₂ atmosphere may be performed at a temperature of about 15° C. to about 30° C.

Exposing the sulfide solid electrolyte particles to an atmosphere having the relative humidity of about 0.02% to about 0.3% may include exposing the particles to an atmosphere with a relatively small amount of H₂O added to nitrogen gas.

Embodiments include an all-solid-state rechargeable battery, including a positive electrode, a negative electrode, and a solid electrolyte layer between the positive electrode and the negative electrode, wherein at least one of the positive electrode, negative electrode, and solid electrolyte layer includes a sulfide solid electrolyte as claimed in claim 1.

### BRIEF DESCRIPTION OF THE DRAWINGS

Features will become apparent to those of ordinary skill in the art by describing in detail exemplary embodiments with reference to the attached drawings, in which:

FIGS. 1 and 2 are cross-sectional views schematically illustrating an all-solid-state rechargeable battery according to some example embodiments; and

FIG. 3 is a Fourier transform infrared spectroscopy (FT-IR) graph of the solid electrolytes of Example 1 and Comparative Examples 1 to 3.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described in detail with reference to the attached drawings so that a person having ordinary skill in the art to which the present disclosure pertains can easily implement the present disclosure. As those skilled in the art would realize, the described embodiments may be modified in various different ways, all without departing from the spirit or scope of the present disclosure.

In addition, unless explicitly described to the contrary, the word “comprise,” and variations such as “comprises” or “comprising,” will be understood to imply the inclusion of stated elements but not the exclusion of any other elements.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface. Here, “or” is not to be construed as an exclusive meaning, for example, “A or B” is construed to include A, B, A+B, and the like.

The average particle diameter may be measured by a method well known to those skilled in the art, for example, by a particle size analyzer, or by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter (D₅₀) may mean the diameter of particles having a cumulative volume of 50 volume % in the particle size distribution. As used herein, when a definition is not otherwise provided, the average particle diameter (D₅₀) means a diameter of particles having a cumulative volume of 50 volume % in the particle size distribution that is obtained by measuring the size (diameter or major axis length) of about 20 particles at random in a scanning electron microscope image.

In some example embodiments, provided is a sulfide solid electrolyte that includes sulfide solid electrolyte particles and a coating layer on a surface of the sulfide solid electrolyte particles, wherein the coating layer includes CO₃²⁻ and PO₄³⁻, and a ratio of a maximum peak intensity of the CO₃²⁻ to a peak intensity of the PO₄³⁻ in an FT-IR analysis is about 0.5 to about 1. The sulfide solid electrolyte has excellent surface properties, high stability against air and moisture, and high retention rate of ionic conductivity over time.

In the FT-IR analysis of the sulfide solid electrolyte, the ratio of the CO₃²⁻ maximum peak intensity to the PO₄³⁻ peak intensity may be, for example, about 0.6 to about 0.9, or about 0.7 to about 0.8. When the ratio is satisfied, the sulfide solid electrolyte has high stability against air and moisture and a high retention rate of ionic conductivity over time.

The coating layer may be coated on at least a portion of the surface of the sulfide solid electrolyte particles. For example, the coating layer may be coated in the form of a continuous film on the surface of the particles, or may be coated in the form of an island on the surface of the particle. Here, the ‘the particles’ refers to sulfide solid electrolyte particles.

The coating layer may further include SO₄²⁻ and/or OH⁻ in addition to CO₃²⁻ and PO₄³⁻. In FT-IR analysis, the ratio of the PO₄³⁻ peak intensity to the SO₄²⁻ peak intensity of the coating layer may be greater than or equal to about 3 and less than or equal to about 4.25, for example, greater than or equal to about 3.5 and less than or equal to about 4.25, or greater than or equal to about 4 and less than or equal to about 4.22. Additionally, the ratio of the CO₃²⁻ maximum peak intensity to the SO₄²⁻ peak intensity may be about 2.5 to about 5, for example about 2.5 to about 4, about 2.8 to about 3.8, or about 3 to about 3.5. When each peak ratio satisfies the above range, the retention rate of ionic conductivity of the sulfide solid electrolyte may be maximized.

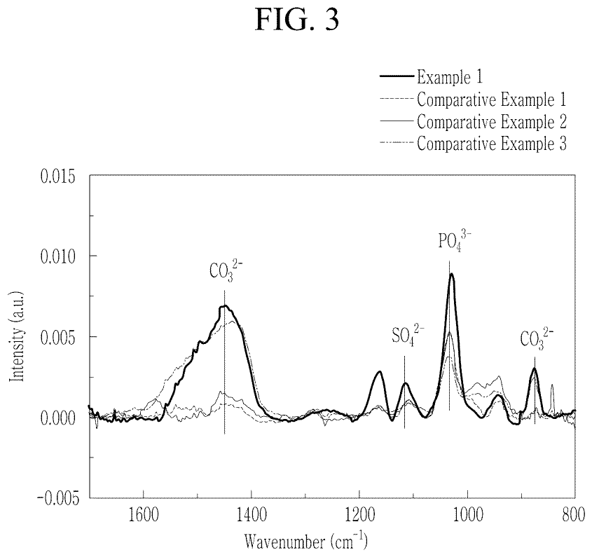

Specifically, in FT-IR analysis of the solid electrolyte, CO₃²⁻ may have a first peak at 1400 cm⁻¹ to 1500 cm⁻¹ and a second peak at 850 cm⁻¹ to 950 cm⁻¹ (see FIG. 3). At this time, the intensity of the first peak is the maximum value of the peak intensity of CO₃²⁻ and may be greater than or equal to about 0.006, and may be greater than the intensity of the second peak. Therefore, the CO₃²⁻ maximum peak intensity may mean the intensity of the first peak. Additionally, in FT-IR analysis of the solid electrolyte, the SO₄²⁻ may have a peak at 1050 cm⁻¹ to 1150 cm⁻¹. The PO₄³⁻ may have a peak at 1000 cm⁻¹ to 1100 cm⁻¹, and the intensity may be greater than or equal to about 0.008.

The sulfide solid electrolyte particles may include, for example Li₂S—P₂S₅, Li₂S—P₂S₅—LiX (wherein X is a halogen element, for example I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n is each an integer and Z is Ge, Zn, or Ga), Li₂S—GeS₂, Li₂S—SiS₂—Li₃PO₄, Li₂S—SiS₂—LiₚMO_{q} (wherein p and q are each an integer and M is P, Si, Ge, B, Al, Ga, or In), or a combination thereof.

Such a sulfide solid electrolyte may be obtained by, for example, mixing Li₂S and P₂S₅ in a mole ratio of about 50:50 to about 90:10 or about 50:50 to about 80:20 and optionally performing heat treatment. Within the above mixing ratio range, a sulfide solid electrolyte having excellent ionic conductivity may be prepared. The ionic conductivity may be further improved by adding SiS₂, GeS₂, B₂S₃, and the like as other components thereto.

Mechanical milling or a solution method may be applied as a mixing method of sulfur-containing raw materials for preparing a sulfide solid electrolyte. The mechanical milling is to make starting materials into particulates by putting the starting materials, grinding balls for ball mills, and the like in a reactor and fervently stirring them. The solution method may be performed by mixing the starting materials in a solvent to obtain a solid electrolyte as a precipitate. In addition, in the case of heat treatment after mixing, crystals of the solid electrolyte may be more robust and ionic conductivity may be improved. For example, the sulfide solid electrolyte may be prepared by mixing sulfur-containing raw materials and performing heat treatment two or more times. In this case, a sulfide solid electrolyte having high ionic conductivity and robustness may be prepared.

For example, the sulfide solid electrolyte particles may include argyrodite-type sulfide. The argyrodite-type sulfide may be, for example, represented by a chemical formula of LiₐM_{b}P_{c}S_{d}Aₑ (wherein a, c, and d are all more than 0 and 12 or less, b, and e are all 0 or more and 12 or less, M is a metal other than Li or a combination of a plurality of metals other than Li, and A is F, Cl, Br, or I), and as a specific example, it may be represented by a chemical formula of Li₇₋ₓPS₆₋ₓAₓ (wherein x is 0.2 or more and 1.8 or less, and A is F, Cl, Br, or I). The argyrodite-type sulfide may be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, and the like.

The sulfide solid electrolyte particles including such argyrodite-type sulfide may have high ionic conductivity close to the range of about 10⁻⁴ to about 10⁻² S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state battery including the same may have improved battery performance such as rate capability, coulombic efficiency, and cycle-life characteristics.

The argyrodite-type sulfide solid electrolyte may be prepared, for example, by mixing lithium sulfide and phosphorus sulfide, and optionally lithium halide. Heat treatment may be performed after mixing them. The heat treatment may include, for example, two or more heat treatment steps.

An average particle diameter (D₅₀) of the sulfide solid electrolyte particles according to some example embodiments may be less than or equal to about 5.0 μm, for example, about 0.1 μm to about 5.0 μm, about 0.1 μm to about 4.0 μm, about 0.1 μm to about 3.0 μm, about 0.1 μm to about 2.0 μm, about 0.5 μm to about 2.0 μm, or about 0.1 μm to about 1.5 μm. Alternatively, the sulfide solid electrolyte particles may be small particles having an average particle diameter (D₅₀) of about 0.1 μm to about 1.0 μm, or large particles having an average particle diameter (D₅₀) of about 1.5 μm to about 5.0 μm, or a mixture of small particles and large particles, depending on the location or purpose of use. The sulfide solid electrolyte particles having this particle diameter range may effectively penetrate between solid particles in a battery, and have excellent contact with the electrode active material and connectivity between solid electrolyte particles. The average particle diameter of the sulfide solid electrolyte particles may be measured using a microscope image, and for example, a particle size distribution may be obtained by measuring the size of about 20 particles in a scanning electron microscope image, and D₅₀ may be calculated therefrom.

An ionic conductivity of the sulfide solid electrolyte particles according to some example embodiments may be 1 mS/cm to 8 mS/cm.

In some example embodiments, provided is a method for preparing a sulfide solid electrolyte which includes: exposing sulfide solid electrolyte particles to an atmosphere having a relative humidity of about 0.02% to about 0.3% to form OH⁻ on the surface of the particles, and exposing the particles with OH formed on the surface to a CO₂ atmosphere to form CO₃²⁻ on the surface. Through the method, a coating layer including CO₃²⁻ and PO₄³⁻ may be disposed on the surface of the sulfide solid electrolyte particles. Through the manufacturing method, a sulfide solid electrolyte having a ratio of CO₃²⁻ maximum peak intensity to PO₄³⁻ peak intensity in a range of about 0.5 to about 1 in the infrared spectroscopy.

If the method of exposing the sulfide solid electrolyte particles to the specific humidity range to form OH on the surface and then, exposing them to the CO₂ atmosphere is applied according to some example embodiments, surface characteristics of the sulfide solid electrolyte are modified, improving stability against moisture and air and thus increasing an ionic conductivity retention rate over the exposure time.

According to the manufacturing method of some example embodiments, the coating layer disposed on the surface of the sulfide solid electrolyte particles may further include SO₄²⁻ and/or OH⁻ in addition to CO₃²⁻ and PO₄³⁻. The ratio of CO₃²⁻ maximum peak intensity to PO₄³⁻ peak intensity, the ratio of PO₄³⁻ peak intensity to SO₄²⁻ peak intensity, and the ratio of CO₃²⁻ maximum peak intensity to SO₄²⁻ peak intensity according to the FT-IR analysis of the solid electrolyte are the same as described above.

The details of the sulfide solid electrolyte particles and the coating layer are as described above and will not be re-described.

The step of exposing the sulfide solid electrolyte particles to the atmosphere having relative humidity of about 0.02% to about 0.3% may be performed by exposing the sulfide-based solid electrolyte particles to an atmosphere by adding a small amount of H₂O to nitrogen gas at a temperature of about 15° C. to about 30° C., for example, about 17° C. to about 25° C. for about 15 minutes to about 1 hour. Herein, the amount of H₂O may correspond to that required for an atmosphere having the relative humidity of about 0.02% to about 0.3%. Through the exposure to the conditions, an appropriate amount of OH⁻ may be formed on the surface of the sulfide solid electrolyte particles, and through the subsequent exposure to the CO₂ atmosphere, the surface characteristics may be modified to improve moisture stability.

The exposure to the CO₂ atmosphere may proceed for about 9 hours to about 72 hours, for example, for about 12 hours to about 72 hours, about 9 hours to about 60 hours, about 12 hours to about 60 hours, about 9 hours to about 48 hours, or about 24 hours to about 48 hours at about 15° C. to about 30° C., for example, about 17° C. to about 25° C. The exposure to the CO₂ atmosphere may be performed by exposing to a dry room including CO₂. Herein, the dry room may include CO₂ in a range of about 0.02% to about 0.1%. Through the exposure to the CO₂ atmosphere under the conditions, appropriate amounts of CO₃²⁻ and PO₄³⁻ may be formed on the surface of the sulfide solid electrolyte particles, which may resultantly improve the moisture stability of the solid electrolyte and increase the ionic conductivity retention rate according to exposure days.

Through the preparing method, the coating layer is well coated on the surface of the sulfide solid electrolyte particles, improving the moisture stability of the sulfide solid electrolyte particles.

In some example embodiments, a solid electrolyte layer including the aforementioned solid electrolyte is provided. The solid electrolyte layer according to some example embodiments includes the aforementioned solid electrolyte, so that it has high stability against moisture and can maintain high ionic conductivity even when exposed for a long time, and because side reactions of the solid electrolyte against moisture are reduced, battery safety and cycle-life characteristics may be improved.

The solid electrolyte layer may further include, in addition to the aforementioned solid electrolyte, another oxide solid electrolyte or a halide solid electrolyte, and optionally may further include a binder.

The oxide inorganic solid electrolyte may include for example Li₁₊ₓTi₂₋ₓAl(PO₄)₃ (LTAP) (0≤x≤4), Li_{1+x+y}AlₓTi₂₋ₓSi_{y}P_{3-y}O₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y≤1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics Li₃₊ₓLa₃M₂O₁₂ (wherein M=Ta, Te, Nb, or Zr; and x is an integer of 1 to 10), or a mixture thereof.

The halide solid electrolyte contains a halogen element as a main component, meaning that a ratio of the halide element to all elements constituting the solid electrolyte may be greater than or equal to 50 mol %, greater than or equal to 70 mol %, greater than or equal to 90 mol %, and/or less than 100 mol %. For example, the halide solid electrolyte may not include a sulfur element.

The halide solid electrolyte may include a lithium element, a metal element other than lithium, and a halogen element. The metal element other than lithium may include Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be F, Cl, Br, I, or a combination thereof and for example it may be Cl, Br, or a combination thereof. For example, the halide solid electrolyte may be represented by LiₐM₁X₆ (wherein M is Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof, X is F, Cl, Br, I, or a combination thereof, and 2≤a≤3). For example, the halide solid electrolyte may include Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, or a combination thereof, but this may vary.

The binder may include, for example, a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, polydimethylsiloxane, polyethyleneoxide, polyvinylpyrrolidone, polyvinylpyridine, chlorosulfonatedpolyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyethylene, polypropylene, an ethylene propylene copolymer, an ethylene propylene diene copolymer, polyamideimide, polyimide, poly(meth)acrylate, polyacrylonitrile, polystyrene, polyurethane, or a combination thereof.

An amount of the binder based on 100 wt % of the solid electrolyte layer may be about 0.1 wt % to about 5 wt %, or about 0.5 wt % to about 3 wt %.

The solid electrolyte layer may optionally further include an alkali metal salt, and/or an ionic liquid, and/or a conductive polymer.

For example, the alkali metal salt may be lithium salt. An amount of lithium salt in the solid electrolyte layer may be greater than or equal to about 1 M or for example about 1 M to about 4 M. In this case, the lithium salt may improve ionic conductivity by improving lithium ion mobility in the solid electrolyte layer.

The lithium salt may be applied without limitation on type, and may include, for example, LiPF₆, LiBF₄, LiSbF₆, LiAsF₆, LiClO₄, LiAlO₂, LiAlCl₄, LiPO₂F₂, LiCl, LiI, LiSCN, LiN(CN)₂, lithium bis(oxalato)borate (LiBOB), lithium difluoro(oxalato)borate (LiDFOB), lithium difluorobis(oxalato)phosphate (LiDFBP), lithium bis(trifluoromethanesulfonyl)imide (LiTFSI), lithium bis(fluorosulfonyl)imide (LiFSI), lithium bis(pentafluoroethanesulfonyl)imide (LiBETI), lithium trifluoromethane sulfonate, lithium tetrafluoroethane sulfonate, or a combination thereof.

For example, the lithium salt may be an imide lithium salt such as LiTFSI, LiFSI, LiBETI, or a combination thereof. The imide lithium salt can maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including a) at least one cation selected from ammonium, pyrrolidinium, pyridinium, pyrimidinium, imidazolium, piperidinium, pyrazolium, oxazolium, pyridazinium, phosphonium, sulfonium, or triazolium cation, and a mixture thereof, and b) at least one anion selected from BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl) imide, 1-butyl-3-methylimidazolium bis(trifluoromethylsulfonyl)amide, and 1-ethyl-3-methylimidazolium bis(trifluoromethylsulfonyl)amide.

In the solid electrolyte layer, a weight ratio of the solid electrolyte and the ionic liquid may be about 0.1:99.9 to about 90:10, for example about 10:90 to about 90:10, about 20:80 to about 90:10, about 30:70 to about 90:10, about 40:60 to about 90:10, or about 50:50 to about 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

In some example embodiments, an all-solid-state rechargeable battery including the aforementioned solid electrolyte is provided. The all-solid-state rechargeable battery includes a positive electrode, a negative electrode, and a solid electrolyte layer between the positive electrode and the negative electrode. The aforementioned solid electrolyte may be included in at least one of the positive electrode, the negative electrode, and the solid electrolyte layer. In one example, an all-solid-state rechargeable battery includes a positive electrode, a negative electrode, and a solid electrolyte layer including the aforementioned solid electrolyte.

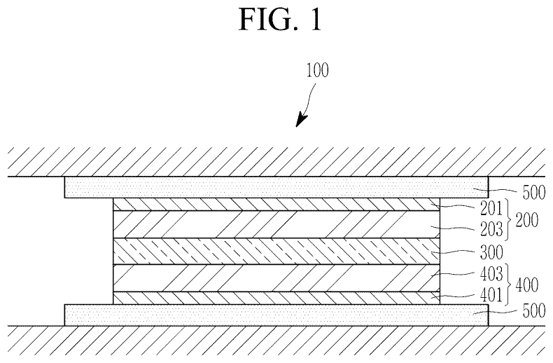

FIG. 1 is a cross-sectional view of an all-solid-state rechargeable battery according to some example embodiments. Referring to FIG. 1, the all-solid-state rechargeable battery 100 may have a structure that an electrode assembly, in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is housed in a battery case. The all-solid-state rechargeable battery 100 may further include at least one elastic layer 500 on the outside of at least either one of the positive electrode 200 and the negative electrode 400. Although FIG. 1 shows one electrode assembly including the negative electrode 400, the solid electrolyte layer 300, and the positive electrode 200, an all-solid-state rechargeable battery can also be manufactured by stacking two or more electrode assemblies.

A negative electrode 400 for an all-solid-state rechargeable battery includes a negative electrode current collector 401 and a negative electrode active material layer 403 on the negative electrode current collector 401. The negative electrode active material layer 403 may include a negative electrode active material, may further include a binder and/or a conductive material, may optionally include the aforementioned solid electrolyte.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si negative electrode active material or a Sn negative electrode active material. The Si negative electrode active material may include silicon, a silicon-carbon composite, SiOₓ (0<x≤2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

For example, the negative electrode active material may include silicon-carbon composite particles. An average particle diameter (D₅₀) of the silicon-carbon composite particles may be, for example, 0.5 μm to 20 μm. The average particle diameter (D₅₀) is measured with a particle size analyzer and means a diameter of particles with a cumulative volume of 50 volume % in the particle size distribution. Silicon may be included in an amount of about 10 wt % to about 60 wt % and carbon may be included in an amount of about 40 wt % to about 90 wt % based on 100 wt % of the silicon-carbon composite particles. For example, the silicon-carbon composite particles may include a core including silicon particles, and a carbon coating layer on the surface of the core. An average particle diameter (D₅₀) of the silicon particles may be about 10 nm to about 1 μm or about 10 nm to about 200 nm in the core. The silicon particles may exist as silicon alone, in the form of a silicon alloy, or in an oxidized form. The oxidized form of silicon may be represented by SiOₓ (0<x≤2). In addition, a thickness of the carbon coating layer may be about 5 nm to about 100 nm.

As an example, the silicon-carbon composite particles may include a core including silicon particles and crystalline carbon, and a carbon coating layer disposed on the surface of the core and including amorphous carbon. For example, in the silicon-carbon composite particles, amorphous carbon may not exist in the core but only in the carbon coating layer. The crystalline carbon may be artificial graphite, natural graphite, or a combination thereof, and the amorphous carbon may be formed from coal pitch, mesophase pitch, petroleum pitch, coal oil, heavy petroleum oil, or a polymer resin (phenolic resin, furan resin, polyimide resin, etc.). Here, an amount of the crystalline carbon may be about 10 wt % to about 70 wt % and an amount of the amorphous carbon may be about 20 wt % to about 40 wt % based on 100 wt % of the silicon-carbon composite particles.

In the silicon-carbon composite particle, the core may include a void in the center. A radius of the void may be about 30 length % to about 50 length % of the radius of the silicon-carbon composite particle.

The aforementioned silicon-carbon composite particles effectively suppress problems such as volume expansion, structural collapse, or particle crushing due to charging and discharging, prevent disconnection of conductive paths, achieve high capacity and high efficiency, and is advantageous to use under a high-voltage or high-speed charging conditions.

The Si negative electrode active material or Sn negative electrode active material may be used by mixing with a carbon negative electrode active material. When using a mixture of Si negative electrode active material or Sn negative electrode active material and carbon negative electrode active material, a mixing ratio thereof may be 1:99 to 90:10 by weight.

An amount of the negative electrode active material in the negative electrode active material layer may be about 95 wt % to about 99 wt %, or about 90 wt % to about 98 wt % based on a total weight of the negative electrode active material layer.

In some example embodiments, the negative electrode active material layer further includes the binder and optionally may further include the conductive material. An amount of the binder in the negative electrode active material layer may be about 1 wt % to about 5 wt % based on a total weight of the negative electrode active material layer. In addition, if a conductive material is further included, the negative electrode active material layer may include about 95 wt % to about 99 wt %, or about 90 wt % to about 98 wt % of the negative electrode active material, about 1 wt % to about 5 wt % of the binder, and about 1 wt % to about 5 wt % of the conductive material.

The binder serves to attach the negative electrode active material particles well to each other and also to attach the negative electrode active material well to the current collector. The binder may be a water-insoluble binder, a water-soluble binder, or a combination thereof.

The water-insoluble binder may be polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose compound capable of imparting viscosity as a type of thickener may be further included. As this cellulose compound, one or more types of carboxymethyl cellulose, hydroxypropylmethyl cellulose, methyl cellulose, or an alkali metal salt thereof may be used. The alkali metal may be Na, K, or Li. The amount of the thickener used may be about 0.1 parts by weight to about 3 parts by weight based on 100 parts by weight of the negative electrode active material.

The conductive material is used to impart conductivity to the electrode, and any material that does not cause chemical change and conducts electrons can be used in the battery. Examples of the conductive material may include a carbon material such as natural graphite, artificial graphite, carbon black, acetylene black, Ketjen black, a carbon fiber, a carbon nanofiber, a carbon nanotube, and the like; a metal material of a metal powder or a metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state rechargeable battery may be a precipitation-type negative electrode. The precipitation-type negative electrode does not include a negative electrode active material during battery assembly, but may refer to a negative electrode in which lithium metal, etc. is precipitated or electrodeposited on the negative electrode during battery charging, thereby serving as a negative electrode active material.

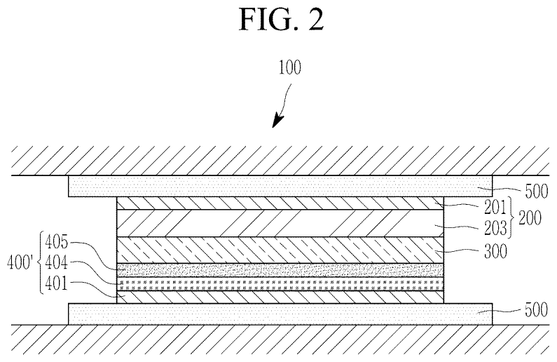

FIG. 2 is a schematic cross-sectional view of an all-solid-state rechargeable battery including a precipitation-type negative electrode. Referring to FIG. 2, the precipitation-type negative electrode 400′ may include a current collector 401 and a negative electrode coating layer 405 on the current collector. In an all-solid-state rechargeable battery having such a precipitation-type negative electrode 400′, initial charging begins in the absence of a negative electrode active material, and when charging, a high-density lithium metal or the like is precipitated between the current collector 401 and the negative electrode coating layer 405 or on the negative electrode coating layer 405 to form a lithium metal layer 404, which can serve as a negative electrode active material. Accordingly, in an all-solid-state rechargeable battery that has been charged at least once, the precipitation-type negative electrode 400′ may include, for example, a current collector 401, a lithium metal layer 404 on the current collector, and a negative electrode coating layer 405 on the metal layer. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

The negative electrode coating layer 405 may also be referred to as a lithium electrodeposition inducing layer or a negative electrode catalyst layer, and may include a metal, a carbon material, or a combination thereof that acts as a catalyst.

The metal may be a lithiophilic metal and may include, for example, gold, platinum, palladium, silicon, silver, aluminum, bismuth, tin, zinc, or a combination thereof, and may be composed of one of these or various types of alloys. If the metal is present in particle form, an average particle diameter (D₅₀) thereof may be less than or equal to about 4 μm, for example, about 10 nm to about 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, Ketjen black, or a combination thereof.

If the negative electrode coating layer 405 includes the metal and the carbon material, the metal and the carbon material may be, for example, mixed in a weight ratio of about 1:10 to about 2:1. Here, the precipitation of the lithium metal may be effectively promoted and improve characteristics of the all-solid-state rechargeable battery. The negative electrode coating layer 405 may include, for example, a carbon material on which a catalyst metal is supported or a mixture of metal particles and carbon material particles.

The negative electrode coating layer 405 may include, for example the lithiophilic metal and amorphous carbon, and in this case, the deposition of lithium metal may be effectively promoted. As a specific example, the negative electrode coating layer 405 may include a composite in which a lithiophilic metal is supported on amorphous carbon.

The negative electrode coating layer 405 may further include a binder, and the binder may be, for example, a conductive binder. Additionally, the negative electrode coating layer 405 may further include general additives such as a filler, a dispersant, an ion conductive agent, and the like.

A thickness of the negative electrode coating layer 405 may be for example about 100 nm to about 20 μm, about 500 nm to about 10 μm, or about 1 μm to about 5 m.

The precipitation-type negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery. The thin film may be formed, for example in a vacuum deposition method, a sputtering method, a plating method, and the like. The thin film may have, for example, a thickness of about 1 nm to about 500 nm.

The lithium metal layer 404 may include lithium metal or lithium alloy. For example, the lithium alloy may be Li—Al alloy, Li—Sn alloy, Li—In alloy, Li—Ag alloy, Li—Au alloy, Li—Zn alloy, Li—Ge alloy, or Li—Si alloy.

A thickness of the lithium metal layer 404 may be 1 μm to 500 μm, 1 μm to 200 μm, 1 μm to 100 μm, or 1 μm to 50 μm. If the thickness of the lithium metal layer 404 is too thin, it is difficult to perform the role of a lithium storage, and if it is too thick, the battery volume may increase and performance may deteriorate.

When applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state rechargeable battery may be suppressed and cycle-life characteristics can be improved.

In some example embodiments, the positive electrode includes a current collector and a positive electrode active material layer on the current collector, wherein the positive electrode active material layer includes a positive electrode active material and a solid electrolyte, and optionally a binder and/or a conductive material. At this time, the positive electrode active material layer may include the solid electrolyte described above.

The positive electrode active material may be applied without limitation as long as it is generally used in all-solid-state rechargeable batteries. For example, the positive electrode active material may be a compound being capable of intercalating and deintercalating lithium, and may include a compound represented by one of the following chemical formulas:

$${Li}_{a} {A}_{1 - b} {X}_{b} {D}_{2} ( 0.9 \leq a \leq 1.8 , 0 \leq b \leq 0.5 ) ;$$

$${Li}_{a} {A}_{1 - b} {X}_{b} {O}_{2 - c} {D}_{c} ( 0.9 \leq a \leq 1.8 , 0 \leq b \leq 0.5 , 0 \leq c \leq 0.05 ) ;$$

$${Li}_{a} {E}_{1 - b} {X}_{b} {O}_{2 - c} {D}_{c} ( 0.9 \leq a \leq 1.8 , 0 \leq b \leq 0.5 , 0 \leq c \leq 0.05 ) ;$$

$${Li}_{a} {E}_{2 - b} {X}_{b} {O}_{4 - c} {D}_{c} ( 0.9 \leq a \leq 1.8 , 0 \leq b \leq 0.5 , 0 \leq c \leq 0.05 ) ;$$

$${Li}_{a} {Ni}_{1 - b - c} {Co}_{b} {X}_{c} {D}_{α} ( 0.9 \leq a \leq 1.8 , 0 \leq b \leq 0.5 , 0 \leq c \leq 0.05 , 0 < α \leq 2 ) ;$$

$${Li}_{a} {Ni}_{1 - b - c} {Co}_{b} {X}_{c} {O}_{2 - α} {T}_{α} ( 0.9 \leq a \leq 1.8 , 0 \leq b \leq 0.5 , 0 \leq c \leq 0.05 , 0 < α < 2 ) ;$$

$${Li}_{a} {Ni}_{1 - b - c} {Co}_{b} {X}_{c} {O}_{2 - α} {T}_{2} ( 0.9 \leq a \leq 1.8 , 0 \leq b \leq 0.5 , 0 \leq c \leq 0.05 , 0 < α < 2 ) ;$$

$${Li}_{a} {Ni}_{1 - b - c} {Mn}_{b} {X}_{c} {D}_{α} ( 0.9 \leq a \leq 1.8 , 0 \leq b \leq 0.5 , 0 \leq c \leq 0.05 , 0 < α \leq 2 ) ;$$

$${Li}_{a} {Ni}_{1 - b - c} {Mn}_{b} {X}_{c} {O}_{2 - α} {T}_{α} ( 0.9 \leq a \leq 1.8 , 0 \leq b \leq 0.5 , 0 \leq c \leq 0.05 , 0 < α < 2 ) ;$$

$${Li}_{a} {Ni}_{1 - b - c} {Mn}_{b} {X}_{c} {O}_{2 - α} {T}_{2} ( 0.9 \leq a \leq 1.8 , 0 \leq b \leq 0.5 , 0 \leq c \leq 0.05 , 0 < α < 2 ) ;$$

$${Li}_{a} {Ni}_{b} {E}_{c} {G}_{d} {O}_{2} ( 0.9 \leq a \leq 1.8 , 0 \leq b \leq 0.9 , 0 \leq c \leq 0.5 , 0.001 \leq d \leq 0.1 ) ;$$

$${Li}_{a} {Ni}_{b} {Co}_{c} {Mn}_{d} {G}_{e} {O}_{2} ( 0.9 \leq a \leq 1.8 , 0 \leq b \leq 0.9 , 0 \leq c \leq 0.5 , 0 \leq d \leq 0.5 , 0.001 \leq e \leq 0.1 ) ;$$

$${Li}_{a} Ni {G}_{b} {O}_{2} ( 0.9 \leq a \leq 1.8 , 0.001 \leq b \leq 0.1 ) ;$$

$${Li}_{a} Co {G}_{b} {O}_{2} ( 0.9 \leq a \leq 1.8 , 0.001 \leq b \leq 0.1 ) ;$$

$${Li}_{a} {Mn}_{1 - b} {G}_{b} {O}_{2} ( 0.9 \leq a \leq 1.8 , 0.001 \leq b \leq 0.1 ) ;$$

$${Li}_{a} {Mn}_{2} {G}_{b} {O}_{4} ( 0.9 \leq a \leq 1.8 , 0.001 \leq b \leq 0.1 ) ;$$

$${Li}_{a} {Mn}_{1 - g} {G}_{g} {PO}_{4} ( 0.9 \leq a \leq 1.8 , 0 \leq g \leq 0.5 ) ;$$

$${Q O}_{2} ; {Q S}_{2} ; {Li Q S}_{2} ;$$

$${V}_{2} {O}_{5} ; {LiV}_{2} {O}_{5} ;$$

$${Li Z O}_{2} ;$$

$${LiNiVO}_{4} ;$$

$${Li}_{( 3 - f )} {{J}_{2} ( {PO}_{4} )}_{3} ( 0 \leq f \leq 2 ) ;$$

$${Li}_{( 3 - f )} {{Fe}_{2} ( {PO}_{4} )}_{3} ( 0 \leq f \leq 2 ) ; and$$

$${Li}_{a} {FePO}_{4} ( 0.9 \leq a \leq 1.8 ) .$$

In the chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

The positive electrode active material may include, for example, a lithium nickel oxide represented by Chemical Formula 11, a lithium cobalt oxide represented by Chemical Formula 12, a lithium iron phosphate compound represented by Chemical Formula 13, a cobalt-free lithium nickel-manganese oxide represented by Chemical Formula 14, or a combination thereof.

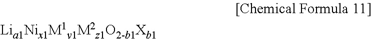

In Chemical Formula 11, 0.9≤a1≤1.8, 0.3≤x1≤1, 0≤y1≤0.7, 0≤z1≤0.7, 0.9≤x1+y1+z1≤1.1, 0≤b1≤0.1, M¹ and M² are one or more elements independently selected from Al, B, Ba, Ca, Ce, Co, Cr, Cu, Fe, Mg, Mn, Mo, Nb, Si, Sn, Sr, Ti, V, W, and Zr, and X is one or more elements selected from F, P, and S.

In Chemical Formula 11, 0.6≤x1≤1, 0≤y1≤0.4, and 0≤z1≤0.4 or 0.8≤x1≤1, 0≤y1≤0.2, and 0≤z1≤0.2.

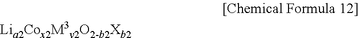

In Chemical Formula 12, 0.9≤a2≤1.8, 0.7≤x2≤1, 0≤y2≤0.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S.

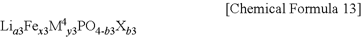

In Chemical Formula 13, 0.9≤a3≤1.8, 0.6≤x3≤1, 0≤y3≤0.4, 0.9≤x3+y3≤1.1, and 0≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn and Zr, and X is one or more elements selected from F, P, and S.

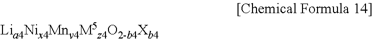

In Chemical Formula 14, 0.9≤a4≤1.8, 0.8≤x4≤1, 0≤y4≤0.2, 0≤z4≤0.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

An average particle diameter (D₅₀) of the positive electrode active material may be about 1 μm to about 25 μm, for example about 3 μm to about 25 μm, about 1 μm to about 20 μm, about 1 μm to about 18 μm, about 3 μm to about 15 μm, or about 5 μm to about 15 μm. For example, the positive electrode active material may include small particles having an average particle diameter (D₅₀) of 1 μm to 9 μm and large particles having an average particle diameter (D₅₀) of 10 μm to 25 μm. The positive electrode active material having this particle size range can be harmoniously mixed with other components within the positive electrode active material layer and can achieve high capacity and high energy density. Here, the average particle diameter means a diameter (D₅₀) of particles having a cumulative volume of 50 volume % in the particle size distribution that is obtained by measuring the size (diameter or length of the major axis) of about 20 particles at random in a scanning electron microscope image for positive electrode active materials.

The positive electrode active material may be in the form of secondary particles made by agglomerating a plurality of primary particles or in the form of single particles. Additionally, the positive electrode active material may have a spherical or close to spherical shape, or may have a polyhedral or irregular shape.

Meanwhile, the positive electrode active material may include a buffer layer on the surface of the particles. The buffer layer may be expressed as a coating layer, a protective layer, etc., and may serve to lower the interfacial resistance between the positive electrode active material and the sulfide solid electrolyte particles. For example, the buffer layer may include lithium-metal-oxide, wherein the metal may be for example one or more elements selected from Al, B, Ca, Ce, Cr, Fe, Mg, Mo, Nb, Si, Sn, Sr, Ta, V, W, and Zr. The lithium-metal-oxide improves the performance of the positive electrode active material by facilitating the movement of lithium ions and electronic conduction, and is improved for lowering the interfacial resistance between the positive electrode active material and solid electrolyte particles.

The positive electrode active material may be included in an amount of about 55 wt % to about 99 wt %, for example about 65 wt % to about 95 wt %, or about 75 wt % to about 91 wt % based on 100 wt % of the positive electrode active material layer.

The binder serves to adhere the positive electrode active material particles to each other and also to properly attach the positive electrode active material to the current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but this may vary.

An amount of the binder may be approximately about 0.1 wt % to about 5 wt % based on 100 wt % of the positive electrode active material layer in the positive electrode active material layer.

The positive electrode active material layer may further include a conductive material. The conductive material is used to impart conductivity to the electrode, and any material that does not cause chemical change and conducts electrons can be used in the battery. Examples thereof may include a carbon material such as natural graphite, artificial graphite, carbon black, acetylene black, ketjen black, a carbon fiber, a carbon nanofiber, a carbon nanotube, and the like; a metal material including copper, nickel, aluminum, silver, etc. in a form of a metal powder or a metal fiber; a conductive polymer such as a polyphenylene derivative; or a mixture thereof.

An amount of the conductive material in the positive electrode active material layer may be 0 wt % to about 3 wt %, about 0.01 wt % to about 2 wt %, or about 0.1 wt % to about 1 wt % based on 100 wt % of the positive electrode active material layer.

The solid electrolyte may be included in an amount of about 0.1 wt % to about 35 wt %, for example about 1 wt % to about 35 wt %, about 5 wt % to about 30 wt %, about 8 wt % to about 25 wt %, or about 10 wt % to about 20 wt % based on 100 wt % of the positive electrode active material layer.

Additionally, the positive electrode active material may be included in an amount of about 65 wt % to about 99 wt % and the solid electrolyte may be included in an amount of about 1 wt % to about 35 wt %, for example the positive electrode active material may be included in an amount of about 80 wt % to about 90 wt %, and the solid electrolyte may be included in an amount of about 10 wt % to about 20 wt % based on a total weight of the positive electrode active material and solid electrolyte in the positive electrode active material layer. If the solid electrolyte is included in the positive electrode at such an amount, the efficiency and cycle-life characteristics of the all-solid-state rechargeable battery can be improved without reducing the capacity.

The positive electrode current collector may include an aluminum foil, but this may vary.

An all-solid-state rechargeable battery may be a unit cell with a structure of positive electrode/solid electrolyte layer/negative electrode, a bicell with a structure of negative electrode/solid electrolyte layer/positive electrode/solid electrolyte layer/negative electrode, or a stacked battery in which the structure of the unit cell is repeated.

The shape of the all-solid-state rechargeable battery may be, for example, various shapes including coin-shaped, button-shaped, sheet-shaped, stacked-shaped, cylindrical, flat, etc. In addition, the all-solid-state rechargeable battery may be applied to a large-sized battery used in an electric vehicle or the like. For example, the all-solid-state rechargeable battery may also be used in hybrid vehicles such as plug-in hybrid electric vehicles (PHEV). In addition, it may be used in a field requiring a large amount of power storage, and may be used, for example, in an electric bicycle or a power tool. In addition, the all-solid-state rechargeable battery may be used in various fields such as portable electronic devices.

Hereinafter, examples and comparative examples of the embodiments in the present disclosure will be described. The following examples are only examples of the embodiments of the present disclosure.

### Example 1

### 1. Preparing of Solid Electrolyte

Argyrodite-type sulfide solid electrolyte particles (Li₆PS₅Cl, D₅₀=3.5 μm) were exposed to an atmosphere having relative humidity of 0.15% by adding a small amount of H₂O to nitrogen gas at a temperature of 20° C. for 20 minutes and then, to a dry room containing 0.03 vol % of CO₂ at 20° C. for 9 hours, manufacturing a solid electrolyte having a coating layer on the surface of the sulfide solid electrolyte particles.

### 2. Manufacturing of Solid Electrolyte Layer

The solid electrolyte was added to an isobutyryl isobutyrate (IBIB) solvent including an acryl binder (SX-A334, Zeon Corp.) to prepare a slurry. The slurry included 98 wt % of the solid electrolyte and 2 wt % of the binder. The slurry was applied onto a PET release film with a blade coater, pre-dried at about 50° C., and dried at about 70° C. under vacuum to form a solid electrolyte layer with a thickness of about 150 μm.

### Comparative Example 1

A solid electrolyte was manufactured in the same manner as in Example 1 except that the sulfide solid electrolyte particles (Li₆PS₅Cl) themselves were used as the solid electrolyte of the solid electrolyte layer.

### Comparative Example 2

A solid electrolyte was manufactured in the same manner as in Example 1 except that the sulfide solid electrolyte particles were exposed to an atmosphere having relative humidity of 0.15% by adding a small amount of H₂O to nitrogen gas at a temperature of 20° C. for 20 minutes to form the solid electrolyte of the solid electrolyte layer, and the CO₂ exposure step was omitted.

### Comparative Example 3

A solid electrolyte was manufactured in the same manner as in Example 1 except that the sulfide solid electrolyte particles were exposed to a dry room containing 0.03 vol % of CO₂ at a temperature of 20° C. for 9 hours to form the solid electrolyte of the solid electrolyte layer, and the exposure step to the atmosphere having relative humidity of 0.15% was omitted.

### Evaluation Example 1: Fourier Transform Infrared Spectroscopy Evaluation

The solid electrolytes according to Example 1 and Comparative Examples 1 to 3 were subjected to Fourier Transform infrared spectroscopy (FT-IR) on their surfaces. The solid electrolytes were measured with respect to infrared spectral spectra by using a Nicolet iS10 spectrometer (Thermo Scientific, Waltham, MA, USA). The infrared spectroscopy results are shown in FIG. 3 and Table 1.

TABLE 1

| | | | | Iₘₐₓ | Iₘₐₓ | |
|---|---|---|---|---|---|---|
| | Iₘₐₓ | I | | (CO₃²⁻)/I | (CO₃²⁻)/I | I (PO₄³⁻)/ |
| Peak intensity | (CO₃²⁻) | (SO₄²⁻) | I (PO₄³⁻) | (PO₄³⁻) | (SO₄²⁻) | I (SO₄²⁻) |
| Example 1 | 0.00684 | 0.00211 | 0.00891 | 0.767677 | 3.2417 | 4.222749 |
| Comparative Example 1 | 0.00084 | 0.00107 | 0.00535 | 0.157009 | 0.7850 | 5.0000 |
| Comparative Example 2 | 0.0016 | 0.00112 | 0.00544 | 0.294118 | 1.4286 | 4.8571 |
| Comparative Example 3 | 0.00597 | 0.000883 | 0.00378 | 1.579365 | 6.7610 | 4.2809 |

Referring to FIG. 3 and Table 1, Example 1 and Comparative Example 2, which were exposed to the atmosphere having relative humidity of 0.15%, exhibited high PO₄³⁻ intensity, but Comparative Examples 1 and 3, which were not exposed to moisture, exhibited low PO₄³⁻ intensity. Comparative Examples 1 and 2, which were not exposed to CO₂ atmosphere, exhibited low CO₃²⁻ maximum peak intensity. Accordingly, because Example 1 exhibited all high PO₄³⁻ and CO₃²⁻ intensity, a ratio of CO₃²⁻ maximum peak intensity to PO₄³⁻ peak intensity was 0.767677.

### Evaluation Example 2: Atmospheric Stability Evaluation Through Retention Rate of Ionic Conductivity

The solid electrolyte in the form of pellets manufactured in Example 1 and Comparative Examples 1 to 3 were prepared as specimens. After preparing a symmetrical cell by disposing an indium electrode with a thickness of 50 μm and a diameter of 13 mm on both sides of each specimen, impedance was measured by using an impedance analyzer (Material Mates 7260) in a two-prove method. The impedance was measured within a frequency range of 0.1 Hz to 1 MHz at an amplitude voltage of 10 mV under an Ar atmosphere at 25° C. Resistance was obtained from a circular arc of an Nyquist plot for the impedance measurement results, and ionic conductivity was calculated by considering an area and a thickness of each specimen. Each solid electrolyte, after measuring ionic conductivity immediately after the synthesis, was allowed to stand in a dry room at −45° C. or less and then, remeasured with respect to the ionic conductivity after three day. The ionic conductivity retention rate may be calculated according to Equation 1 below. In Table 2, the ionic conductivity retention rate immediately after the synthesis of the solid electrolytes is represented as 100% at 0 day, and the ionic conductivity retention rate calculated by Equation 1 below is represented as the ionic conductivity retention rate after 3 days.

$$Ionic conductivity retention rate = ( Ionic conductivity measured after 3 days ) / \\ ( Ionic conductivity measured immediately \\ after the synthesis of the solid electrolytes ) \times 100 \qquad [ Equation 1 ]$$

TABLE 2

Ionic conductivity after storage
(mS/cm), (Retention rate, %)

| Composition | 0 day | 3 day |
|---|---|---|
| Example 1 | 100 | 89.57 |
| Comparative Example 1 | 100 | 80.26 |
| Comparative Example 2 | 100 | 70.18 |
| Comparative Example 3 | 100 | 79.51 |

Referring to Table 2, the solid electrolyte of Example 1 was confirmed to exhibit a much higher ionic conductivity retention rate after three days' exposure than those of Comparative Examples 1 to 3.

Lithium-ion batteries currently on the market use electrolyte solutions that include flammable organic solvents, and thus there is a risk of overheating and fire if a short circuit occurs. For this reason, an all-solid-state rechargeable battery using a solid electrolyte instead of an electrolyte solution is being proposed.

All-solid-state rechargeable batteries do not use flammable organic solvents, which significantly reduces the risk of fire or explosion in the event of a short-circuit. Therefore, these all-solid-state rechargeable batteries may significantly improve safety compared to lithium-ion batteries that use electrolyte solutions that include flammable organic solvents.

The above description is only one embodiment for implementing the all-solid-state rechargeable battery according to the present disclosure, and the present disclosure is not limited to the aforementioned embodiment, and as claimed in the following claims, it will be understood that the technical spirit of the present disclosure encompasses a range in which various modifications can be implemented without departing from the gist of the present disclosure.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### REFERENCE NUMERALS

100: All-solid-state rechargeable battery
200: positive electrode
201: positive electrode current collector
203: positive electrode active material layer
300: solid electrolyte layer
400: negative electrode
401: negative electrode current collector
403: negative electrode active material layer
400″: precipitation-type negative electrode
404: lithium metal layer
405: negative electrode coating layer
500: elastic layer

What is claimed is:

1. A sulfide solid electrolyte, comprising:
sulfide solid electrolyte particles; and
a coating layer on a surface of the sulfide solid electrolyte particles, wherein:
the coating layer comprises CO₃²⁻ and PO₄³⁻, and
a ratio of a maximum peak intensity of the CO₃²⁻ to a peak intensity of the PO₄³⁻ in infrared spectroscopy is about 0.5 to about 1.

2. The sulfide solid electrolyte as claimed in claim 1, wherein the coating layer further comprises SO₄²⁻.

3. The sulfide solid electrolyte as claimed in claim 2, wherein a ratio of the PO₄³⁻ peak intensity to the SO₄²⁻ peak intensity of the coating layer is greater than or equal to about 3 and less than or equal to about 4.25.

4. The sulfide solid electrolyte as claimed in claim 2, wherein a ratio of the CO₃²⁻ maximum peak intensity to the SO₄²⁻ peak intensity is about 2.5 to about 5.

5. The sulfide solid electrolyte as claimed in claim 1, wherein the coating layer further comprises OH⁻.

6. The sulfide solid electrolyte as claimed in claim 1, wherein the coating layer is coated on at least a portion of a surface of the sulfide solid electrolyte particles.

7. The sulfide solid electrolyte as claimed in claim 1, wherein the coating layer is a continuous film on the surface of a sulfide solid electrolyte particles.

8. The sulfide solid electrolyte as claimed in claim 1, wherein the coating layer is an island on the surface of a sulfide solid electrolyte particles.

9. The sulfide solid electrolyte as claimed in claim 1, wherein the sulfide solid electrolyte particles comprise argyrodite-type sulfide.

10. The sulfide solid electrolyte as claimed in claim 9, wherein the argyrodite-type sulfide comprises at least one of Li₃PS₄, Li₇P₃Sₙ, Li₇PS₆, Li₆PS₅Cl, Li₆PS₅Br, Li_{5.8}PS_{4.8}Cl_{1.2}, and Li_{6.2}PS_{5.2}Br_{0.8}.

11. The sulfide solid electrolyte as claimed in claim 1, wherein an average particle diameter of the sulfide solid electrolyte particles is about 0.1 μm to about 5.0 μm.

12. The sulfide solid electrolyte as claimed in claim 1, wherein an average particle diameter of the sulfide solid electrolyte particles is about 0.1 μm to about 2.0 μm.

13. The sulfide solid electrolyte as claimed in claim 1, wherein an ionic conductivity of the sulfide solid electrolyte particles is about 1 mS/cm to about 8 mS/cm.

14. A method for preparing a sulfide solid electrolyte, the method comprising:
exposing sulfide solid electrolyte particles to an atmosphere having a relative humidity of about 0.02% to about 0.3% to form OH⁻ on a surface of the sulfide solid electrolyte particles; and
exposing the particles with OH⁻ formed on the surface to a CO₂ atmosphere to form CO₃²⁻ on the surface.

15. The method as claimed in claim 14, wherein exposing the particles to the CO₂ atmosphere is performed for about 9 hours to about 72 hours.

16. The method as claimed in claim 14, wherein exposing the sulfide solid electrolyte particles to the CO₂ atmosphere comprises exposing the sulfide solid electrolyte particles to a dry room comprising CO₂.

17. The method as claimed in claim 16, wherein the dry room comprises about 0.02 vol % to about 0.1 vol % of the CO₂.

18. The method as claimed in claim 14, wherein:
exposing the sulfide solid electrolyte particles to the atmosphere having the relative humidity of about 0.02% to about 0.3% is performed at a temperature of about 15° C. to about 30° C., and
exposing the sulfide solid electrolyte particles to the CO₂ atmosphere is performed at a temperature of about 15° C. to about 30° C.

19. The method as claimed in claim 14, wherein exposing the sulfide solid electrolyte particles to an atmosphere having the relative humidity of about 0.02% to about 0.3% comprises exposing the sulfide solid electrolyte particles to an atmosphere with a relatively small amount of H₂O added to nitrogen gas.

20. An all-solid-state rechargeable battery, comprising:
a positive electrode;
a negative electrode; and
a solid electrolyte layer between the positive electrode and the negative electrode,
wherein at least one of the positive electrode, negative electrode, and solid electrolyte layer comprises a sulfide solid electrolyte as claimed in claim 1.
